(19) United States
(12) Patent Application Publication
(10) Pub. No.: US 2014/0308486 A1
(43) Pub. Date: Oct. 16, 2014

(54) METHOD FOR MAKING A FIBROUS STRUCTURE COMPRISING A PLURALITY OF DISCRETE BOND SITES AND FIBROUS STRUCTURES MADE THEREWITH

(71) Applicant: The Procter & Gamble Company, Cincinnati, OH (US)

(72) Inventors: William Joseph BUTSCH, Harrison, OH (US); John Gerhard MICHAEL, Cincinnati, OH (US); Andre MELLIN, Amberley Village, OH (US); Christopher Scott KRAUS, Sunman, IN (US); Alessandra MASSA, Blue Ash, OH (US)

(73) Assignee: The Procter & Gamble Company, Cincinnati, OH (US)

(21) Appl. No.: 14/247,620

(22) Filed: Apr. 8, 2014

Related U.S. Application Data
(60) Provisional application No. 61/811,884, filed on Apr. 15, 2013.

(51) Int. Cl. B32B 3/10; B29C 70/24

(52) U.S. Cl. CPC B32B 3/10; B29C 70/24
USPC 428/195.1; 156/290

(57) ABSTRACT

The present invention relates to a method for making a fibrous structure, particularly in order to provide a fibrous structure comprising a bonding material which is bonded to a nonwoven substrate at a plurality of discrete bond sites. The plurality of discrete bond sites comprises first, second and third areas. The first, second and third areas comprise a plurality of individual parallelograms which have different compacted fibers relative to each others. The first, second and third areas comprise a plurality of individual parallelograms which have different densities of compacted fibers relative to each other. The bonding material is made of a plurality of filaments comprising a hydroxyl polymer.

### FIELD OF THE INVENTION

The present invention relates to fibrous structures comprising at least three regions of different density, high density regions that represent discrete bond sites of the fibrous structure, intermediate density regions, and low density regions relative to one another. More particularly, the present invention relates to a fibrous structure comprising a high density region that represents a discrete thermal bond site that is adjacent to one or more low density regions and one or more intermediate density regions and a method for making such a fibrous structure. Even more particularly, the present invention relates to a fibrous structure comprising a bonding material which is bonded to a nonwoven substrate at a plurality of discrete thermal bond sites, high density regions, which are adjacent to one or more low density regions and one or more intermediate density regions.

### BACKGROUND OF THE INVENTION

It is known to emboss a specific pattern on a fibrous structure by passing the fibrous structure through a nip formed by a first and a second rolls under thermal and pressure bonding conditions. In general, the pattern may be reproduced only on a first roll and the second roll remains plain and non-patterned. For instance, the first roll may be patterned with diamond-shaped pins. Then, the first roll compresses a fibrous structure against the second roll which has a smooth and plain surface. However, as the diamond-shaped pins of the first roll contact the plain surface of the second roll, the edges of the diamond-shaped pins will start wearing down. The resulting thermal bonds and thus, the resulting embossed pattern will start being less defined after a short period of time.

There is thus a need to develop a method to make a fibrous structure wherein the definition of the pattern applied on the first and/or second rolls will be maintained over the time. i.e. the first and second rolls will not wear down when contacting with each other. There is a need to emboss a thermal bonding pattern better defined compared to the one resulting from a fibrous structure compressed against a roll patterned with diamond-shaped pins.

Further, fibrous structures comprising a surface which include depressions, i.e. a plurality of discrete bond sites, are known in the art. Consumers find such fibrous structures to exhibit improved drape, flexibility, and/or softness and an aesthetically appealing pattern of depressions.

Consumers further appreciate a sanitary tissue product that they can discard in the toilets after a single use. However, the sanitary tissue products comprising known fibrous structures fail to be completely flushable because they comprise insoluble materials such as thermoplastic materials.

There is thus a need to provide fibrous structures readily more water soluble after its use.

### SUMMARY OF THE INVENTION

The present invention fulfills the needs described above by providing a method for making a fibrous structure comprising at least three regions of different density and a fibrous structure made thereby.

In one example of the present invention, a fibrous structure comprising at least three regions of different density wherein a high density region is adjacent to one or more low density regions and one or more intermediate density regions, is provided.

In another example of the present invention, a method for making a fibrous structure comprising the steps of providing a nonwoven substrate, depositing a bonding material onto the nonwoven substrate and bonding the bonding material to the nonwoven substrate at a plurality of discrete bond sites (high density regions) by passing the fibrous structure through a nip formed by a first and a second roll. The first roll comprises a plurality of helically oriented lands substantially parallel to the machine direction, for example the helically oriented lands are positioned at an angle of 45° or less and/or less than 35° and/or less than 25° and/or less than 18° and/or less than 15° and/or less than 10° and/or greater than 0° and/or greater than 2° and/or greater than 5° from the machine direction (MD). The second roll comprising a plurality of helically oriented lands substantially parallel to the rotational axis of the second roll, for example being positioned at an angle, for example the helically oriented lands are positioned at an angle of less than 45° and/or less than 35° and/or less than 25° and/or less than 18° and/or less than 15° and/or less than 10° and/or greater than 0° and/or greater than 2° and/or greater than 5° from the cross machine direction (CD), is provided.

In another example of the present invention, a method for making a fibrous structure, the method comprising the steps of:

a. providing a nonwoven substrate having a machine direction and cross machine direction;

b. depositing a bonding material onto the nonwoven substrate; and

c. bonding at a plurality of discrete bond sites the bonding material to the nonwoven substrate to form the fibrous structure, by passing the nonwoven substrate through a nip formed by a first and a second roll, wherein the first roll comprises a plurality of lands wherein each land of the first roll is substantially parallel to the machine direction of the nonwoven substrate, and wherein the second roll comprises a plurality of lands, wherein each land of the second roll is positioned at an angle ranging from 10° to 30° relative to a rotational axis of the second roll, wherein the plurality of discrete bond sites comprises first, second and third areas, wherein the first areas comprise a plurality of individual parallelograms having compacted fibers, wherein each individual parallelogram of the first areas is delimited on each of its four sides by an individual parallelogram of the second areas, wherein the second areas comprise compacted fibers, the fibers of the first areas are more compacted than the fibers of the second areas and wherein each individual parallelogram of the first areas is contiguous at each of its four corners with an individual parallelogram of the third areas, wherein the third areas comprise uncompacted fibers; characterized in that the bonding material is made of a plurality of filaments comprising a hydroxyl polymer; wherein the bonding material is bonded to the nonwoven substrate at the nip to a pressure of at least 300 pli of nip width, is provided.

In still another example of the present invention, a fibrous structure comprising a nonwoven substrate, a bonding material, wherein the bonding material is bonded to the nonwoven substrate at a plurality of discrete bond sites, the plurality of discrete bond sites comprises first, second and third areas, wherein the first areas comprise a plurality of individual parallelograms having compacted fibers, wherein each individual parallelogram of the first areas is delimited on each of its four sides by an individual parallelogram of the second areas, wherein the second areas comprise compacted fibers, the fibers of the first areas are more compacted than the fibers of the second areas and wherein each individual parallelogram of the first areas is contiguous at each of its four corners with an individual parallelogram of the third areas, wherein the third areas comprise uncompacted fibers, characterized in that the bonding material is made of a plurality of filaments comprising a hydroxyl polymer, is provided.

In yet another example of the present invention, a fibrous structure comprising a nonwoven substrate and a bonding material. The bonding material is bonded to the nonwoven substrate at a plurality of discrete bond sites. The plurality of discrete bond sites comprises first, second and third areas. The first areas comprise a plurality of individual rhomboids, which are the discrete bond sites (high density regions) having compacted fibers. Each individual rhomboid is delimited on each of its four sides by an individual rhomboid of the second areas. The second areas comprise partially compacted fibers. The fibers of the first areas are more compacted than the fibers of the second areas. Each individual rhomboid of the first areas is contiguous at each of its four corners with an individual rhomboid of the third areas. The third areas comprise uncompacted fibers. The bonding material is made of a plurality of filaments comprising a hydroxyl polymer.

In even yet another example of the present invention, a thermally bonded fibrous structure comprising three or more regions of different density comprising a high density thermally bonded region that is adjacent to one or more low density regions and one or more intermediate density regions, is provided.

Accordingly, the present invention provides novel fibrous structures and method for making such fibrous structures.

### BRIEF DESCRIPTION OF THE DRAWINGS

FIG. 1 is a schematic representation of one example of a method for making a fibrous structure according to the present invention.

FIG. 2 is a partly broken-away view of nip formed by a first and second rolls suitable to be used for the present invention.

FIG. 3 is a schematic representation of the bonding pattern of one example of a method for making a fibrous structure according to the present invention.

FIG. 4 is a schematic representation of an example of a portion of a fibrous structure in accordance with the present invention; and

FIG. 5 is an image of a portion of an example of a fibrous structure in accordance with the present invention.

### DETAILED DESCRIPTION OF THE INVENTION

### Definitions

“Fibrous structure” as used herein means a structure that comprises one or more fibrous elements. In one example, a fibrous structure according to the present invention means an association of fibrous elements that together form a structure capable of performing a function.

The fibrous structures of the present invention may be homogeneous or may be layered. If layered, the fibrous structures may comprise at least 2 to 16 layers.

In one example, the fibrous structures of the present invention are disposable. For example, the fibrous structures of the present invention are non-textile fibrous structures. In another example, the fibrous structures of the present invention are flushable, such as toilet tissue.

“Fibrous element” as used herein means an elongate particulate having a length greatly exceeding its average diameter, i.e. a length to average diameter ratio of at least about 10. A fibrous element may be a filament or a fiber. In one example, the fibrous element is a single fibrous element rather than a yarn comprising a plurality of fibrous elements.

The fibrous elements of the present invention may be spun from polymer melt compositions via suitable spinning operations, such as meltblowing and/or spunbonding and/or they may be obtained from natural sources such as vegetative sources, for example trees.

“Filament” as used herein means an elongate particulate as described above that exhibits a length of greater than or equal to 5.08 cm (2 in.) and/or greater than or equal to 7.62 cm (3 in.) and/or greater than or equal to 10.16 cm (4 in.) and/or greater than or equal to 15.24 cm (6 in.).

Filaments are typically considered continuous in nature. Filaments are relatively longer than fibers. Non-limiting examples of filaments include meltblown and/or spunbond filaments. Non-limiting examples of polymers that can be spun into filaments include natural polymers, such as starch, starch derivatives, cellulose, such as rayon and/or lyocell, and cellulose derivatives, hemicellulose, hemicellulose derivatives, and synthetic polymers including, but not limited to thermoplastic polymer filaments, such as polyesters, nylons, polyolefins such as polypropylene filaments, polyethylene filaments, and biodegradable thermoplastic fibers such as polylactic acid filaments, polyhydroxyalkanoate filaments, polyesteramide filaments and polycaprolactone filaments.

“Fiber” as used herein means an elongate particulate as described above that exhibits a length of less than 5.08 cm (2 in.) and/or less than 3.81 cm (1.5 in.) and/or less than 2.54 cm (1 in.).

Fibers are typically considered discontinuous in nature. Non-limiting examples of fibers include pulp fibers, such as wood pulp fibers, and synthetic staple fibers such as polypropylene, polyethylene, polyester, copolymers thereof, rayon, glass fibers and polyvinyl alcohol fibers.

In one example of the present invention, a fiber may be a naturally occurring fiber, which means it is obtained from a naturally occurring source, such as a vegetative source, for example a tree and/or plant. Such fibers are typically used in papermaking and are oftentimes referred to as papermaking fibers. Papermaking fibers useful in the present invention include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web. Also applicable to the present invention are fibers derived from recycled paper, which may contain any or all of the above categories of fibers as well as other non-fibrous polymers such as fillers, softening agents, wet and dry strength agents, and adhesives used to facilitate the original papermaking.

In addition to the various wood pulp fibers, other cellulosic fibers such as cotton linters, rayon, lyocell and bagasse fibers can be used in the fibrous structures of the present invention.

“Bonding material” as used herein means any suitable material capable of bonding to the nonwoven substrate of the present invention.

“Land” as used herein means a raised area or a protrusion of the surface of a roll on the entire circumference of the roll. A roll is engraved with a pattern of a plurality of lands which can have any forms and are separated by grooves. The pattern of the plurality of lands can be a pattern of rings, helices, splines, or a checkerboard pattern.

“Groove” as used herein means a depression or an intaglio of the surface of a roll on the entire circumference of a roll.

“Rhomboid” as used herein means a parallelogram in which adjacent sides are of equal or unequal lengths and angles are oblique.

“Machine Direction” or “MD” as used herein means the direction parallel to the flow of the fibrous structure through the papermaking machine and/or product manufacturing equipment.

“Cross Machine Direction” or “CD” as used herein means the direction perpendicular to the machine direction in the same plane of the fibrous structure and/or paper product comprising the fibrous structure.

“Hydroxyl polymer” as used herein includes any hydroxyl-containing polymer that can be incorporated into a fibrous structure of the present invention, such as into a fibrous structure in the form of a fibrous element. In one example, the hydroxyl polymer of the present invention includes greater than 10% and/or greater than 20% and/or greater than 25% by weight hydroxyl moieties. In another example, the hydroxyl within the hydroxyl-containing polymer is not part of a larger functional group such as a carboxylic acid group.

Non-limiting examples of hydroxyl polymers in accordance with the present invention include polyols, such as polyvinyl alcohol, polyvinyl alcohol derivatives, polyvinyl alcohol copolymers, starch, starch derivatives, starch copolymers, chitosan, chitosan derivatives, chitosan copolymers, cellulose, cellulose derivatives such as cellulose ether and ester derivatives, cellulose copolymers, hemicellulose, hemicellulose derivatives, hemicellulose copolymers, gums, arabinans, galactans, proteins and various other polysaccharides and mixtures thereof.

In one example, a hydroxyl polymer of the present invention is a polysaccharide.

In another example, a hydroxyl polymer of the present invention is a non-thermoplastic polymer.

In another example, a hydroxyl polymer of the present invention is a starch. Well known modifications of hydroxyl polymers, such as natural starches, include chemical modifications and/or enzymatic modifications. For example, natural starch can be acid-thinned, hydroxy-ethylated, hydroxy-propylated, and/or oxidized. In addition, the hydroxyl polymer may comprise dent corn starch hydroxyl polymer.

In another example, a hydroxyl polymer of the present invention is a polyvinyl alcohol. Polyvinyl alcohols herein can be grafted with other monomers to modify its properties. A wide range of monomers has been successfully grafted to polyvinyl alcohol. Non-limiting examples of such monomers include vinyl acetate, styrene, acrylamide, acrylic acid, 2-hydroxyethyl methacrylate, acrylonitrile, 1,3-butadiene, methyl methacrylate, methacrylic acid, vinylidene chloride, vinyl chloride, vinyl amine and a variety of acrylate esters. Polyvinyl alcohols comprise the various hydrolysis products formed from polyvinyl acetate. In one example the level of hydrolysis of the polyvinyl alcohols is greater than 70% and/or greater than 88% and/or greater than 95% and/or about 99%.

“Pounds per linear inch” or “pli” as used herein means the amount of pressure, in pounds, per linear inch across the face of two rolls as they come together. “Pounds per linear inch” or “pli” is used to calculate the roll force. For load, 1 pli=17.857 97 kg/m. For pounds of force per linear inch, 1 pli=175.1268 N/m.

“Solid additive” “as used herein means an additive that is capable of being applied to a surface of a fibrous structure in a solid form.

“Non-thermoplastic” as used herein means, with respect to a material, such as a fibrous element as a whole and/or a polymer within a fibrous element, that the fibrous element and/or polymer exhibits no melting point and/or softening point, which allows it to flow under pressure, in the absence of a plasticizer, such as water, glycerin, sorbitol, urea and the like.

“Non-cellulose-containing” as used herein means that less than 5% and/or less than 3% and/or less than 1% and/or less than 0.1% and/or 0% by weight of cellulose polymer, cellulose derivative polymer and/or cellulose copolymer is present in fibrous element. In one example, “non-cellulose-containing” means that less than 5% and/or less than 3% and/or less than 1% and/or less than 0.1% and/or 0% by weight of cellulose polymer is present in fibrous element.

“Basis Weight” as used herein is the weight per unit area of a sample reported in lbs/3000 ft² or g/m².

“Ply” or “Plies” as used herein means an individual fibrous structure optionally to be disposed in a substantially contiguous, face-to-face relationship with other plies, forming a multiple ply fibrous structure. It is also contemplated that a single fibrous structure can effectively form two “plies” or multiple “plies”, for example, by being folded on itself.

“Sanitary tissue product” as used herein means a soft, low density (i.e. <about 0.15 g/cm³) fibrous structure useful as a wiping implement for post-urinary and post-bowel movement cleaning (toilet tissue), for otorhinolaryngological discharges (facial tissue), and multi-functional absorbent and cleaning uses (absorbent towels). The sanitary tissue product may be convolutedly wound upon itself about a core or without a core to form a sanitary tissue product roll. In one example, the sanitary tissue product of the present invention comprises one or more fibrous structures according to the present invention.

### Method for Making Fibrous Structures

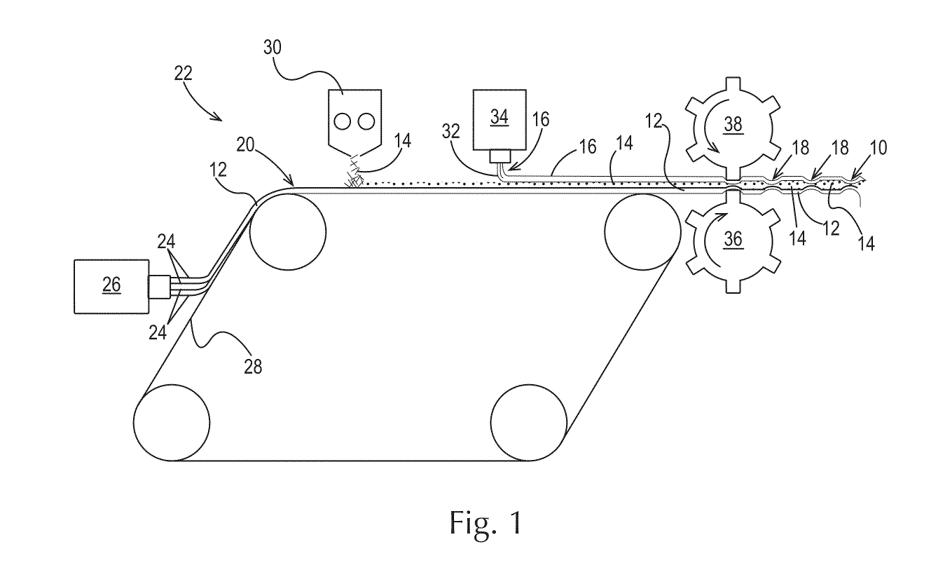

FIG. 1 illustrates one example of a method for making a fibrous structure (10) of the present invention.

As shown in FIG. 1, the method (22) comprises a step of providing a nonwoven substrate (12). The step of providing the nonwoven substrate (12) may comprise providing a parent roll (not shown) of a nonwoven substrate (12) and unrolling the nonwoven substrate (12) to make it accessible for deposition of a bonding material (16).

In another example, the step of providing a nonwoven substrate (12) may comprise the step of spinning a polymer composition to form fibrous elements, such as filaments (24), from a die (26). The filaments (24) may be collected on a collection device, such as a belt (28), to form a nonwoven substrate (12).

Optionally, in another example, the method may comprise a step of depositing a plurality of solid additives (14) onto the nonwoven substrate (12). The step of depositing a plurality of solid additives (14) onto the nonwoven substrate (12) may comprise airlaying the plurality of solid additives (14) using an airlaying former (30). A non-limiting example of a suitable airlaying former (30) is available from Dan-Web of Aarhus, Denmark.

Hence, the plurality of solid additives (14) is positioned between the nonwoven substrate (12) and the bonding material (16).

The plurality of discrete bond sites comprises first, second and third areas. The first areas comprise a plurality of individual rhomboids having compacted fibers. Each individual rhomboid of the first areas is delimited on each of its four sides by an individual rhomboid of the second areas. The second areas comprise compacted fibers. The fibers of the first areas are more compacted than the fibers of the second areas. Each individual rhomboid of the first areas is contiguous at each of its four corners with an individual rhomboid of the third areas. The third areas comprise uncompacted fibers. The bonding material is made of a plurality of filaments comprising a hydroxyl polymer. The bonding material is bonded to the nonwoven substrate at the nip to a pressure of at least 300 pli (pounds per linear inch) of nip width.

### Solid Additives

“Solid additive” as used herein means an additive that is capable of being applied to a surface of a fibrous structure in a solid form. In other words, the plurality of solid additives (14) of the present invention can be delivered directly to a surface (20) of the nonwoven substrate (12) without a liquid phase being present, i.e. without melting the plurality of solid additives (14) and without suspending the plurality of solid additive (14) in a liquid vehicle or carrier. As such, the plurality of solid additives (14) of the present invention does not require a liquid state or a liquid vehicle or carrier in order to be delivered to a surface (20) of a nonwoven substrate (12). The plurality of solid additives (14) of the present invention may be delivered via a gas or combinations of gases. In one example, in simplistic terms, a solid additive is an additive that when placed within a container, does not take the shape of the container immediately after placing the additive in the container.

In one example, the step of contacting the plurality of solid additives (14) with a bonding material (16) comprises the step of depositing one or more filaments (32) of the bonding material (16) produced from a die (34) such that the bonding material (16) contacts at least a portion (in one example all or substantially all) of the plurality of solid additives (14).

In one example of the present invention, the method comprises a step of depositing a bonding material onto the nonwoven substrate (12) (in the absence or not of a plurality of solid additives (14)). In that step, the bonding material (16) is directly deposited onto the nonwoven substrate (12) from a die (34) in the form of one or more filaments (32).

Once the bonding material (16) is in place, a step of bonding (24) the bonding material (16) to the nonwoven substrate (12) occurs. The bonding material (16) is bonded to the nonwoven substrate (12) at a plurality of discrete bond sites (18).

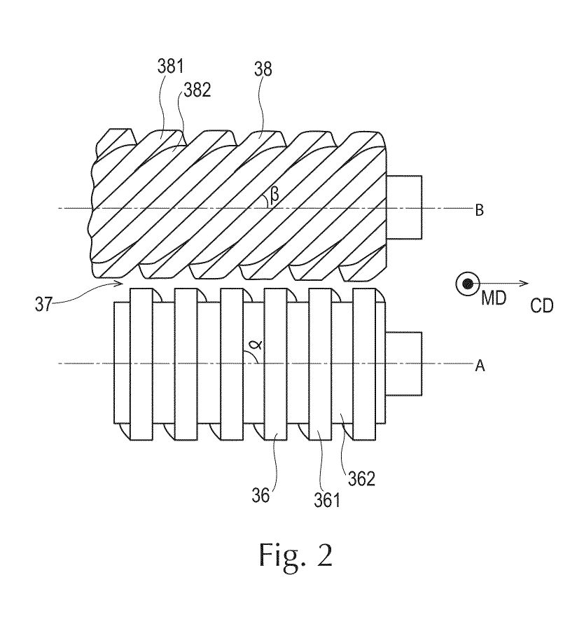

FIG. 2 shows a schematic representation of a nip (37) formed by a first and second rolls (36, 38).

The step of bonding the bonding material (16) to the nonwoven substrate (12) comprises a thermal bonding operation. The step of bonding comprises passing the fibrous structure through a nip (37) formed by a first and a second roll (36, 38). The first and second rolls (36, 38) comprise a pattern that is translated into the plurality of discrete bond sites (18) formed in the fibrous structure (10). In one example, the nonwoven substrate (12) is contacted with steam (not shown) before, for example immediately before, entering the nip (37).

In one example, the first roll (36) comprises a plurality of helically oriented lands (361). The helically oriented lands (361) of the first roll (36) are oriented substantially parallel to the machine direction. In another way, the helically orientedlands (361) of the first roll (36) are oriented substantially perpendicular (angle α is 45° or less) to the rotational axis A of the first roll (36). The rotational axis A of the first roll (36) is parallel to the cross machine direction (CD). The helically oriented lands (361) of the first roll (36) are contiguous to one or more grooves (362). The helically oriented lands (361) of the first roll (36) may have any forms, e.g. a pattern of helices, splines, parallelogram shaped lands, rectangle shaped lands or a checkerboard pattern.

In one example, the second roll (38) comprises a helical pattern of a plurality of lands (381) and grooves (382). The helically oriented lands (381) of the second roll (38) are oriented substantially parallel to the cross machine direction. In another way, the helically oriented lands (381) of the second roll (38) are oriented substantially parallel (angle β is less than 45°) to the rotational axis B of the second roll (38). For example, the helically oriented lands (381) of the second roll (38) may be positioned at an angle β ranging from 10° to 30° and/or from 12° to 20° and/or from 14° to 18° relative to the rotational axis B of the second roll (38). The helically oriented lands (381) of the second roll (38) are contiguous to one or more grooves (382). The helically oriented lands (381) of the second roll (38) may have any forms, e.g. a pattern helices, splines, parallelogram shaped lands, rectangle shaped lands or a checkerboard pattern.

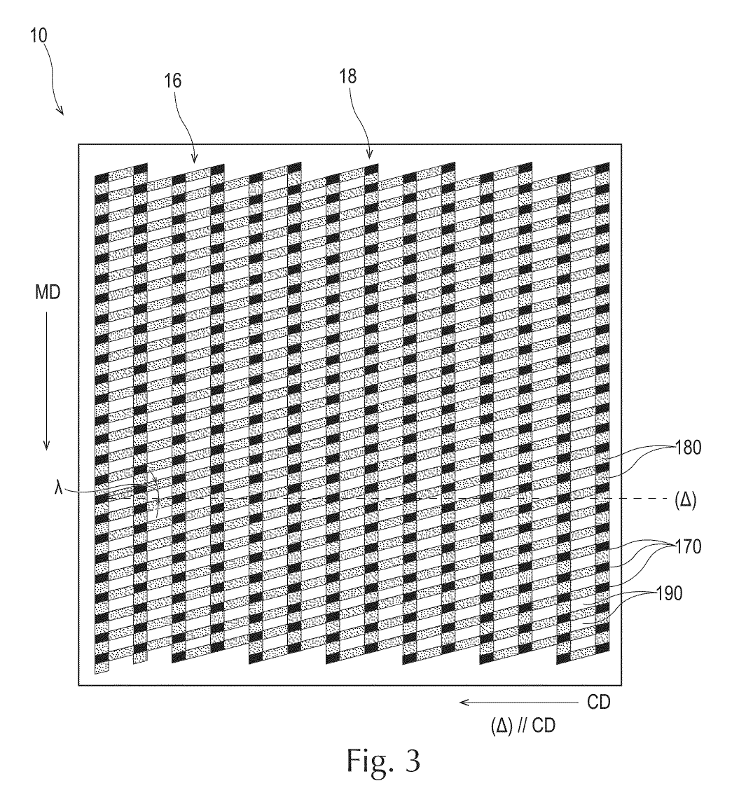

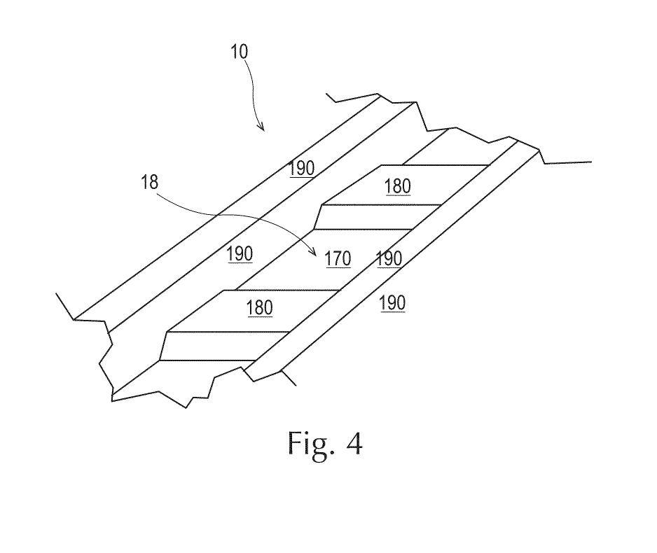

When the fibrous structure (10) is passed through the nip (37) between the first and second rolls (36, 38), a plurality of discrete bond sites (18), high density regions, is formed in the fibrous structure (10). FIG. 3 illustrates a schematic representation of the bonding pattern of one example of the method. In FIGS. 3 and 4, which is a representation of a portion of a fibrous structure (10) of the present invention, the fibrous structure (10) is viewed from the side comprising the bonding material (16). The bonding pattern comprises plurality of discrete bond sites (18), which are high density regions (170). One or more, in this case a plurality of discrete bond sites (18) (the high density regions (170)) are adjacent to one or more low density regions (190) and one or more intermediate density regions (180).

The high density regions (170), which are the discrete bond sites (18) may comprise a plurality of individual rhomboids having compacted fibers. The high density regions (170) of the fibrous structure (10) are formed when a land (361) of the first roll (36) traverses a land (381) of the second roll (38).

Since the lands (381) of the second roll (38) in this example are positioned at an angle β ranging from 10° to 30° and/or from 12° to 20° and/or from 14° to 18° relative to the rotational axis B of the second roll (38), one land (381) of the second roll (38) traverses one land (361) of the first roll (36) at a high density region (170), i.e. a discrete bond site (18) during a first time. However, when the same land (381) of the second roll (38) traverses the same land (361) of the first roll (36) during a second time, it will not be at the same portion of the lands of the first and second rolls (36, 38) that it was during the first time. In other words, the lands of the first and second rolls (36, 38) do not intersect each other at the same locations every time. In other words, in one example, the first and second rolls (36, 38) exhibit different diameters such that one of the rolls precesses the other roll such that it is relatively rare that the same portions of the lands on the different rolls do not contact each other.

These structural features differ from a bonding step when the first and second rolls are identical and comprise a plurality of lands such that the first and second rolls compress the fibrous structure at the points where the lands of the first and second rolls intersect every time. Because the lands of the first and second rolls always intersect at the same locations, the same portions are always in contact during the bonding step. This results in rapid wear at the points of intersection of the lands of the first and second rolls.

In one example of the present invention, the wearing of the lands of the first and second rolls (36, 38) is avoided by the specific orientation of the lands (381) in the second roll (38) relative to the lands (361) in the first roll (36) and by the precession of the rolls when the rolls are different in diameter.

In one example, each discrete bond site (18), for example an individual parallelogram, such as a rhomboid, of the high density regions (170) is delimited on each of its four sides by an individual parallelogram, such as a rhomboid, of the intermediate density regions (180). The intermediate density regions (180) are formed when a land (361) of the first roll (36) traverses a groove (382) of the second roll (38). The intermediate density regions (180) are also formed when a land (381) of the second roll (38) traverses a groove (362) of the first roll (36). The intermediate density regions (180) comprise partially compacted fibers. However, the fibers of the high density regions (170) are more compacted than the fibers of the intermediate density regions (180).

The intermediate density regions (180) may protrude either upwardly from a surface of the fibrous structure (10) or upwardly from the opposing surface of the fibrous structure (10).

In another example, each discrete bond site (18), for example an individual parallelogram, such as a rhomboid, of the high density regions (170) is contiguous at each of its four corners with an individual parallelogram, such as a rhomboid, of the low density regions (190). The low density regions (190) are formed when a groove (362) of the first roll (36) traverses a groove (382) of the second roll (38). Hence, the low density regions (190) comprise uncompacted fibers.

There is an equal number of each of the high density regions (170) and the low density regions (190). There are two times the number of intermediate regions (180) compared to the number of high density regions (170) or low density regions (190).

In one example, since each land (381) of the second roll (38) is positioned at an angle ranging from 10° to 30°, or from 12° to 20° or from 14° to 18° relative to the rotational axis B of the second roll (38), the plurality of high density regions (170), the individual parallelograms, such as rhomboids, form parallel lines oriented at an angle λ (FIG. 3) ranging from 10° to 30°, or from 12° to 20° or from 14° to 18° relative to the cross machine direction. In FIG. 3, the plurality of high density regions (170), the individual parallelograms, such as rhomboids, form parallel lines oriented at an angle λ relative to a line (Δ) which is parallel to the cross machine direction. The line (Δ) is passing through the center of each high density region (170), the individual parallelogram, such as rhomboid, forming a horizontal line.

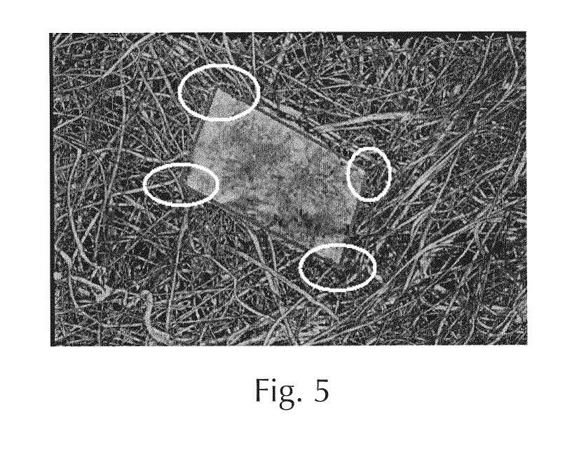

FIG. 5 is an image of a discrete bond site (18), a high density region (170) of a fibrous structure (10) illustrating the crisp, sharp, well-defined, high definition corners of the discrete bond site (18), the high density region (170).

In the present invention, the bonding material (16) may be made of a plurality of filaments comprising a hydroxyl polymer, for example a starch, such as crosslinked starch

### Hydroxyl Polymers

Non-limiting examples of hydroxyl polymers in accordance with the present invention include polyols, such as polyvinyl alcohol, polyvinyl alcohol derivatives, polyvinyl alcohol copolymers, starch, starch derivatives, starch copolymers, chitosan, chitosan derivatives, chitosan copolymers, cellulose, cellulose derivatives such as cellulose ether and ester derivatives, cellulose copolymers, hemicellulose, hemicellulose derivatives, hemicellulose copolymers, gums, arabinans, galactans, proteins and various other polysaccharides and mixtures thereof.

In one example, a hydroxyl polymer of the present invention is a polysaccharide.

“Polysaccharides” as used herein means natural polysaccharides and polysaccharide derivatives and/or modified polysaccharides. Suitable polysaccharides include, but are not limited to, starches, starch derivatives, chitosan, chitosan derivatives, cellulose, cellulose derivatives, hemicellulose, hemicellulose derivatives, gums, arabinans, galactans and mixtures thereof. The polysaccharide may exhibit a weight average molecular weight of from 10,000 to 40,000,000 g/mol and/or greater than 100,000 and/or greater than 1,000,000 and/or greater than 3,000,000 and/or greater than 3,000,000 to 40,000,000.

Non-cellulose and/or non-cellulose derivative and/or non-cellulose copolymer hydroxyl polymers, such as non-cellulose polysaccharides may be selected from the group consisting of: starches, starch derivatives, chitosan, chitosan derivatives, hemicellulose, hemicellulose derivatives, gums, arabinans, galactans and mixtures thereof.

In another example, a hydroxyl polymer of the present invention is a non-thermoplastic polymer.

The hydroxyl polymer may have a weight average molecular weight of from 10,000 g/mol to 40,000,000 g/mol and/or greater than 100,000 g/mol and/or greater than 1,000,000 g/mol and/or greater than 3,000,000 g/mol and/or greater than 3,000,000 g/mol to 40,000,000 g/mol. Higher and lower molecular weight hydroxyl polymers may be used in combination with hydroxyl polymers having a certain desired weight average molecular weight.

In another example, a hydroxyl polymer of the present invention is a starch. Well known modifications of hydroxyl polymers, such as natural starches, include chemical modifications and/or enzymatic modifications. For example, natural starch can be acid-thinned, hydroxy-ethylated, hydroxy-propylated, and/or oxidized. In addition, the hydroxyl polymer may comprise dent corn starch hydroxyl polymer.

In another example, a hydroxyl polymer of the present invention is a polyvinyl alcohol. Polyvinyl alcohols herein can be grafted with other monomers to modify its properties. A wide range of monomers has been successfully grafted to polyvinyl alcohol. Non-limiting examples of such monomers include vinyl acetate, styrene, acrylamide, acrylic acid, 2-hydroxyethyl methacrylate, acrylonitrile, 1,3-butadiene, methyl methacrylate, methacrylic acid, vinylidene chloride, vinyl chloride, vinyl amine and a variety of acrylate esters. Polyvinyl alcohols comprise the various hydrolysis products formed from polyvinyl acetate. In one example the level of hydrolysis of the polyvinyl alcohols is greater than 70% and/or greater than 88% and/or greater than 95% and/or about 99%.

Generally, the fibrous structure (10) exhibits a basis weight of greater than 10 g/m² and/or greater than 14 g/m² and/or greater than 20 g/m² and/or less than about 100 g/m² and/or less than about 70 g/m² and/or less than about 60 g/m² and/or less than about 50 g/m² and/or less than about 40 g/m². In the present invention, the fibrous structure (10) has a basis weight ranging from 20 g/m² to 50 g/m².

When the bonding material (16), which may be considered a scrim material, is made of a plurality of filaments comprising a hydroxyl polymer, the step of bonding the material (16) to the nonwoven substrate (12) requires a relatively high pressure of at least 300 pli (pounds per linear inch) of nip width or at least 350 pli (pounds per linear inch) of nip width or at least 400 pli (pounds per linear inch) of nip width to achieve the bonding. The temperature for the bonding step is between 300° F. (149° C.) and 450° F. (232° C.) or between 350° F. (177° C.) and 400° F. (204° C.). In one example, under processing conditions for bonding, the temperature of the bonding step is within 50° F. of the Tg of the hydroxyl polymer, when no more than 10% by weight of a plasticizer, such as water, is present in the filaments.

It has been found that the pressure ranges are suitable for fibrous structures (10) having a basis weight ranging from 20 g/m² to 50 g/m².

When the bonding material (16) is bonded to the nonwoven substrate (12) at the nip (37) of the first and second rolls (36, 38) at a pressure of at least 300 pli (pounds per linear inch) of nip width, the resulting bonding pattern is better defined because of the applied high pressure and also because the pluralities of lands of the first and second rolls (36, 38) wear significantly less due to the specific orientation of the lands of the first and second rolls (36, 38).

In the contrary, when a first roll is patterned with diamond-shaped pins and is in contact against a second roll which has a smooth and plain surface, such high pressure will lead to an increased wearing of the diamond-shaped pins. This results irreparably to a bonding pattern with a loose definition.

The fibrous structure may also be subjected to other post-processing operations such as embossing, tuft-generating operations, gear rolling, which includes passing the fibrous structure (10) through a nip formed between two engaged gear rolls, moisture-imparting operations, free-fiber end generating operations, and surface treating operations to form a finished fibrous structure.

The method for making a fibrous structure of the present invention (22) may be close coupled (where the fibrous structure is convolutedly wound into a roll prior to proceeding to a converting operation) or directly coupled (where the fibrous structure is not convolutedly wound into a roll prior to proceeding to a converting operation) with a converting operation to emboss, print, deform, surface treat, or other post-forming operation known to those in the art. For purposes of the present invention, direct coupling means that the fibrous structure (10) can proceed directly into a converting operation rather than, for example, being convolutedly wound into a roll and then unwound to proceed through a converting operation.

In one example, one or more plies of the fibrous structure according to the present invention may be combined with another ply of fibrous structure to form a multi-ply sanitary tissue product. In one example, the multi-ply sanitary tissue product may be formed by combining two or more plies of fibrous structure according to the present invention. In another example, two or more plies of fibrous structure according to the present invention may be combined to form a multi-ply sanitary tissue product such that the solid additives present in the fibrous structure plies are adjacent to each of the outer surfaces of the multi-ply sanitary tissue product.

### Fibrous Structures

FIG. 4 is a schematic representation of one example of a fibrous structure (10) in accordance with the present invention.

As illustrated in FIGS. 1 and 4, the fibrous structure (10) of the present invention may comprise a nonwoven substrate (12), a bonding material (16), which may be considered a scrim material, which is bonded to the nonwoven substrate (12) at a plurality of discrete bond sites (18).

The plurality discrete bond sites (18) are where at least a portion of the bonding material (16) and a portion of the nonwoven substrate (12) are connected to one another, such as via a thermal bond, or a bond created by applying high pressure to both the bonding material (16) and the nonwoven substrate (12).

In the present invention, the bonding material (16) may comprise any suitable material capable of bonding to the nonwoven substrate (12) of the present invention. In one example, the bonding material (16) comprises a material that can be thermally bonded to the nonwoven substrate (12) of the present invention.

The bonding material (16) may be present in the fibrous structure (10) of the present invention at a basis weight of greater than 0.1 and/or greater than 0.3 and/or greater than 0.5 and/or greater than 1 and/or greater than 2 g/m² and/or less than 10 and/or less than 7 and/or less than 5 and/or less than 4 g/m².

In the present invention, the bonding material (16) is made of a plurality of filaments comprising a hydroxyl polymer, for example starch, such as crosslinked starch.

Non-limiting examples of suitable nonwoven substrates useful in the present invention include fibrous structures, films and mixtures thereof.

In one example, the nonwoven substrate (12) comprises a plurality of filaments comprising a hydroxyl polymer. The hydroxyl polymer may be selected from the group consisting of polysaccharides, derivatives thereof, polyvinyl alcohol, derivatives thereof and mixtures thereof. In one example, the hydroxyl polymer comprises a starch and/or starch derivative. The nonwoven substrate (12) may exhibit a basis weight of greater than 10 g/m² and/or greater than 14 g/m² and/or greater than 20 g/m² and/or greater than 25 g/m² and/or greater than 30 g/m² and/or greater than 35 g/m² and/or greater than 40 g/m² and/or less than 100 g/m² and/or less than 90 g/m² and/or less than 80 g/m².

In one example, the fibrous structures (10) has a basis weight ranging from 20 g/m² to 50 g/m².

When both the nonwoven substrate (12) and the bonding material (16) are made of a plurality of filaments comprising a hydroxyl polymer, the solubility of the fibrous structure (10) in water is further increased. After its use, the fibrous structure (10) is able to be flushed in toilets even better than when only the bonding material (16) is made of a plurality of filaments comprising a hydroxyl polymer.

Optionally, in another example, the fibrous structure (10) may comprise a plurality of solid additives (14) which are positioned between the nonwoven substrate (12) and the bonding material (16).

Non-limiting examples of suitable solid additives include hydrophilic inorganic particles, hydrophilic organic particles, hydrophobic inorganic particles, hydrophobic organic particles, naturally occurring fibers, non-naturally occurring particles and non-naturally occurring fibers.

In one example, the naturally occurring fibers may comprise wood pulp fibers, trichomes, seed hairs, protein fibers, such as silk and/or wool, and/or cotton linters. In one example, the solid additive comprises chemically treated pulp fibers. Non-limiting examples of chemically treated pulp fibers are commercially available from Georgia-Pacific Corporation.

In another example, the non-naturally occurring fibers may comprise polyolefin fibers, such as polypropylene fibers, and/or polyamide fibers.

In another example, the hydrophilic inorganic particles are selected from the group consisting of: clay, calcium carbonate, titanium dioxide, talc, aluminum silicate, calcium silicate, alumina trihydrate, activated carbon, calcium sulfate, glass microspheres, diatomaceous earth and mixtures thereof.

In one example, hydrophilic organic particles of the present invention may include hydrophobic particles the surfaces of which have been treated by a hydrophilic material. Non-limiting examples of such hydrophilic organic particles include polyesters, such as polyethylene terephthalate particles that have been surface treated with a soil release polymer and/or surfactant. Another example is a polyolefin particle that has been surface treated with a surfactant.

In another example, the hydrophilic organic particles may comprise superabsorbent particles and/or superabsorbent materials such as hydrogels, hydrocolloidal materials and mixtures thereof. In one example, the hydrophilic organic particle comprises polyacrylate. Other Non-limiting examples of suitable hydrophilic organic particles are known in the art.

In another example, the hydrophilic organic particles may comprise high molecular weight starch particles (high amylose-containing starch particles), such as Hylon 7 available from National Starch and Chemical Company.

In another example, the hydrophilic organic particles may comprise cellulose particles.

In another example, the hydrophilic organic particles may comprise compressed cellulose sponge particles.

The plurality of solid additives (14) of the present invention may have different geometries and/or cross-sectional areas that include round, elliptical, star-shaped, rectangular, trilobal and other various eccentricities.

In one example, the solid additive may exhibit a particle size of less than 6 mm and/or less than 5.5 mm and/or less than 5 mm and/or less than 4.5 mm and/or less than 4 mm and/or less than 2 mm in its maximum dimension.

“Particle” as used herein means an object having an aspect ratio of less than about 25/1 and/or less than about 15/1 and/or less than about 10/1 and/or less than 5/1 to about 1/1. A particle is not a fiber as defined herein.

The plurality of solid additives (14) may be present in the fibrous structure (10) of the present invention at a level of greater than about 1 and/or greater than about 2 and/or greater than about 4 and/or to about 20 and/or to about 15 and/or to about 10 g/m².

In one example, the plurality of solid additives (14) is present in the fibrous structure (10) of the present invention at a level of greater than 5% and/or greater than 10% and/or greater than 20% to about 50% and/or to about 40% and/or to about 30%.

In one example, the solid additives (14) may comprise fibers, for example wood pulp fibers. The wood pulp fibers may be softwood pulp fibers and/or hardwood pulp fibers. In one example, the wood pulp fibers comprise eucalyptus pulp fibers. In another example, the wood pulp fibers comprise Southern Softwood Kraft (SSK) pulp fibers

The solid additives (14) may be chemically treated. In one example, the solid additives (14) comprise softening agents and/or are surface treated with softening agents. Non-limiting examples of suitable softening agents include silicones and/or quaternary ammonium compounds, such as PROSOFT® available from Hercules Incorporated. In one example, the solid additives (14) may comprise a wood pulp treated with a quaternary ammonium compound softening agent, an example of which is available from Georgia-Pacific Corporation. One advantage of applying a softening agent only to the solid additives versus applying it to the entire fibrous structure (10) and/or nonwoven substrate (12) and/or bonding material (16), ensures that the softening agent softens those components of the entire fibrous structure (10) that need softening compared to the other components of the entire fibrous structure.

In one example, the plurality of solid additives (14) may be uniformly distributed on a surface (20) of the nonwoven substrate (12) as shown in FIG. 5.

The plurality of solid additives (14) is made of hydrophilic fibers or hydrophilic organic particles. The plurality of solid additives (14) tends therefore to retain absorbed water between the binding material (16) and the nonwoven substrate (12) in order to provide a dryer outer surface.

The plurality of solid additives (14) also modifies the properties of the fibrous structure (10) by increasing its friction properties relative to a fibrous structure only made of a nonwoven substrate.

The fibrous structure (10) of the present invention may comprise a surface softening agent. The surface softening agent may be applied to a surface of the fibrous structure (10). The softening agent may comprise a silicone and/or a quaternary ammonium compound.

In one example, the fibrous structure (10) may comprise a nonwoven substrate (12), which has a plurality of solid additives (14) present on both of the nonwoven substrates opposite surfaces that are positioned between the nonwoven substrate surfaces and a bonding material (16) that is bonded to each of the nonwoven substrates. The plurality of solid additives (14) may be different or the same and may be present at different levels or at same levels and may be uniformly distributed on the opposite surfaces of the nonwoven substrate. The bonding material (16) may be different or the same and may be present at different levels or at same levels and be bonded to opposite surfaces of the nonwoven substrate at one or more bond sites. The bonding material (16) is made of a plurality of filaments comprising a hydroxyl polymer.

In another example, the fibrous structure (10) may comprises the plurality of solid additives (14) positioned on opposite surfaces of the nonwoven substrate (12) and the bonding material (16) bonded to the opposite surfaces of the nonwoven substrate (12) at a plurality of discrete bond sites (18) such that the plurality of solid additives (14) are positioned between the bonding material (16) and the nonwoven substrate (12).

The fibrous structure (10) of the present invention may be used as a sanitary tissue product. Consumers appreciate a sanitary tissue product that they can discard in the toilets after a single use. When the bonding material (16) is made of a plurality of filaments comprising a hydroxyl polymer, the solubility of the bonding material (16) in water is increased. After its use, the fibrous structure (10) is able to be flushed in toilets whereas a fibrous structure made of thermoplastic filaments would not be suitable for this purpose because such a fibrous structure would not sufficiently dissolve or disintegrate.

Hence, the sanitary tissue products comprising the fibrous structure (10) are better flushable because they comprise soluble materials such as hydroxyl polymers.

The design of the bonding pattern used in the method of the present invention and imparted to the fibrous structures of the present invention may be any suitable design. In one example, the design of the bonding pattern is chosen using modeling and dimensions analysis of thermal bonded structures on bending stiffness of webs

Consumers appreciate a sanitary tissue product that has good flexibility when held in the hand. This characteristic allows them to easily form implements for cleaning as well as delivers the impression of softness. This characteristic flexibility is often referred to as drape. The web structure contributes greatly to this characteristic. By manipulating the flexibility of the substrate, the notion of bulk can also be communicated to the consumer.

Various properties contribute to the overall impression of flexibility and the measurement of drape in a disordered structure. Some example properties include fiber to fiber bonding strength, fiber material modulus, fiber dimensions, thermal bond pattern (bond to bond distances, bond dimensions, roll geometry, etc), basis weight, and caliper (both localized and bulk).

By combining terms like the ones listed above in non dimensional ways, optimal web characteristics, operating spaces and pattern design can be determined. In another example, the fibrous structure (10) of the present invention may comprise one ply within a multi-ply sanitary tissue product.

In another example, a multi-ply sanitary tissue product comprising two or more plies of the fibrous structure (10) according to the present invention is provided. In one example, the two or more plies may be combined to form a multi-ply sanitary tissue product such that the plurality of solid additives (14) are adjacent to at least one outer surface and/or each of the outer surfaces of the multi-ply sanitary tissue product.

### Non-Limiting Example of a Fibrous Structure

The materials used in the Examples are as follows:

CPI 050820-156 is an acid-thinned, dent corn starch with a weight average molecular weight of 2,000,000 g/mol supplied by Corn Products International, Westchester, Ill.

Hyperfloc NF301, a nonionic polyacrylamide (PAAM) has a weight average molecular weight between 5,000,000 and 6,000,000 g/mol, is supplied by Hychem, Inc., Tampa, Fla.

Aerosol MA-80-PG is an anionic sodium dihexyl sulfosuccinate surfactant supplied by Cytec Industries, Inc., Woodland Park, N.J.

In a 40:1 APV Baker twin-screw extruder (“cook extruder”) with eight temperature zones (Zones 1-8), a 2.2 wt % NF301 PAAM solution is mixed with CPI 050820-156 starch, ammonium chloride, Aerosol MA-80-PG surfactant, and water in zone 1. This mixture is then conveyed down the barrel through zones 2 through 8 and cooked into a melt-processed hydroxyl polymer composition. The composition in the extruder is 42% water where the make-up of solids is 97.2% CPI 050820-156, 1.5% Aerosol MA-80-PG, and 0.8% Hyperfloc NF301 polyacrylamide, and 0.5% ammonium chloride. The extruder barrel temperature set points for each zone are shown in Table 1 below:

TABLE 1

| Zone | 1 | 2 | 3 | 4 | 5 | 6 | 7 | 8 |
|---|---|---|---|---|---|---|---|---|
| Temperature (° C.) | 15 | 15 | 15 | 50 | 160 | 160 | 185 | 185 |

The temperature of the aqueous polysaccharide melt composition exiting the 40:1 extruder is between 170 and 175° C. The aqueous polysaccharide melt composition is held at 170 to 175° C. for 1 to 2 minutes. From the extruder, the aqueous polysaccharide melt composition is fed to a Mahr gear pump, and then delivered to a second extruder (a “flash extruder”). The second extruder is a 13:1 APV Baker twin screw, which serves to cool the melt by venting a stream to atmospheric pressure. The second extruder also serves as a location for additives to the aqueous polysaccharide melt composition. Particularly, a second stream of 2.2 wt % Hyperfloc NF301 polyacrylamide is introduced at a level of 0.3% on a solids basis. This raises the total Hyperfloc NF301 level to 1.1% of the solids. The material that is not vented is conveyed down the extruder to a second Mahr melt pump. From here, the aqueous polysaccharide melt composition is delivered to a series of static mixers where a crosslinking agent, crosslinking facilitator, and water are added. The aqueous polysaccharide melt composition at this point in the process is 50-55% total solids. On a solids basis the aqueous polysaccharide melt composition is comprised of 91.1% CPI 050820-156 starch, 5% crosslinking agent, 2% ammonium chloride (crosslinking facilitator), 1.5% surfactant, 0.8% Hyperfloc NF221 PAAM, and 0.2% Hyperfloc NF301 PAAM. From the static mixers the aqueous polysaccharide melt composition is delivered to a melt blowing die via a melt pump. Polysaccharide filaments are produced from the aqueous polysaccharide melt composition by the melt blowing die. The filaments are collected on a collection device, such as a belt, for example a patterned belt, to produce a nonwoven substrate (12).

Wood pulp fibers, Southern Softwood Kraft available as roll comminution pulp, is disintegrated by a hammermill and conveyed to an airlaid former via a blower. The wood pulp fibers are deposited onto the nonwoven substrate (12) as a plurality of solid additives (14).

A bonding material (16), such as a plurality of filaments comprising a hydroxyl polymer that has the same make up and made by the same process as the nonwoven substrate above, except that the bonding material exhibits a basis weight of from about 0.1 g/m² to about 10 g/m² is provided. The plurality of filaments comprising the hydroxyl polymer is laid down on the plurality of solid additives (14), which are already on a surface of the nonwoven substrate (12) to form the fibrous structure (10).

The fibrous structure (10) is then subjected to a bonding process wherein the bonding material (16) is bonded to the nonwoven substrate (12) at a plurality of discrete bond sites (18).

The step of bonding the bonding material (16) to the nonwoven substrate (12) comprises a thermal bonding operation. The step of bonding comprises passing the fibrous structure through a nip (37) formed by a first and a second roll (36, 38). The first and second rolls (36, 38) comprise a pattern that is translated into the plurality of discrete bond sites (18) formed in the fibrous structure (10) as described above.

When the fibrous structure (10) is passed through the nip (37) between the first and second rolls (36, 38), a plurality of discrete bond sites (18) is formed in the fibrous structure (10).

When the bonding material (16) is made of a plurality of filaments comprising a hydroxyl polymer, the step of bonding the material (16) to the nonwoven substrate (12) requires a pressure of 400 pli (pounds per linear inch) of nip width at a temperature of 400° F. (204° C.).

In this non-limiting, the plurality of solid additives (14) which are made of wood pulp fibers is positioned between the nonwoven substrate (12) and the bonding material (16).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for making a fibrous structure, the method comprising the steps of:
a. providing a nonwoven substrate having a machine direction and cross machine direction;
b. depositing a bonding material onto the nonwoven substrate; and
c. bonding at a plurality of discrete bond sites the bonding material to the nonwoven substrate to form the fibrous structure, by passing the nonwoven substrate through a nip formed by a first and a second roll, wherein the first roll comprises a plurality of lands wherein each land of the first roll is substantially parallel to the machine direction of the nonwoven substrate, and wherein the second roll comprises a plurality of lands, wherein each land of the second roll is positioned at an angle ranging from 10° to 30° relative to a rotational axis of the second roll, wherein the plurality of discrete bond sites comprises first, second and third areas, wherein the first areas comprise a plurality of individual parallelograms having compacted fibers, wherein each individual parallelogram of the first areas is delimited on each of its four sides by an individual parallelogram of the second areas, wherein the second areas comprise compacted fibers, the fibers of the first areas are more compacted than the fibers of the second areas and wherein each individual parallelogram of the first areas is contiguous at each of its four corners with an individual parallelogram of the third areas, wherein the third areas comprise uncompacted fibers; characterized in that the bonding material is made of a plurality of filaments comprising a hydroxyl polymer; wherein the bonding material is bonded to the nonwoven substrate at the nip to a pressure of at least 300 pli of nip width.

2. The method according to claim 1 wherein the hydroxyl polymer is selected from the group consisting of polysaccharides and derivatives thereof and mixtures thereof.

3. The method according to claim 1 wherein the hydroxyl polymer is selected from the group consisting of polyvinyl alcohol and derivatives thereof and mixtures thereof.

4. The method according to claim 1 wherein the hydroxyl polymer comprises a starch and/or starch derivative.

5. The method according to claim 1 wherein a plurality of solid additives is deposited onto a surface of the nonwoven substrate.

6. The method according to claim 1 wherein the bonding material is non thermoplastic.

7. The method according to claim 1 wherein the fibrous structure has a basis weight ranging from 20 g/m² to 100 g/m².

8. The method according to claim 1 wherein the method further comprises the step of combining two or more of the fibrous structures to form a multi-ply sanitary tissue product.

9. The method according to claim 1 wherein the method further comprises the step of contacting the nonwoven substrate with steam prior to the bonding step.

10. A fibrous structure comprising a nonwoven substrate, a bonding material, wherein the bonding material is bonded to the nonwoven substrate at a plurality of discrete bond sites, the plurality of discrete bond sites comprises first, second and third areas, wherein the first areas comprise a plurality of individual parallelograms having compacted fibers, wherein each individual parallelogram of the first areas is delimited on each of its four sides by an individual parallelogram of the second areas, wherein the second areas comprise compacted fibers, the fibers of the first areas are more compacted than the fibers of the second areas and wherein each individual parallelogram of the first areas is contiguous at each of its four corners with an individual parallelogram of the third areas, wherein the third areas comprise uncompacted fibers, characterized in that the bonding material is made of a plurality of filaments comprising a hydroxyl polymer.

11. The fibrous structure according to claim 10 wherein the hydroxyl polymer is selected from the group consisting of polysaccharides and derivatives thereof and mixtures thereof.

12. The fibrous structure according to claims 10 wherein the hydroxyl polymer is selected from polyvinyl alcohol and derivatives thereof and mixtures thereof.

13. The fibrous structure according to claims 10 wherein the hydroxyl polymer comprises a starch and/or starch derivative.

14. The fibrous structure according to claim 10 wherein the bonding material is non thermoplastic.

15. The fibrous structure according to claim 10 wherein the fibrous structure comprises a plurality of solid additives, wherein the plurality of solid additives are positioned between the nonwoven substrate and the bonding material.

16. The fibrous structure according to claim 10 wherein the nonwoven substrate comprises a plurality of filaments comprising a hydroxyl polymer.

17. A thermally bonded fibrous structure comprising three or more regions of different density comprising a high density thermally bonded region that is adjacent to one or more low density regions and one or more intermediate density regions.

18. The fibrous structure according to claim 17 wherein the fibrous structure comprises a plurality of filaments comprising a hydroxyl polymer.

19. The fibrous structure according to claim 17 wherein the fibrous structure comprises a plurality of solid additives.

20. The fibrous structure according to claim 17 wherein the fibrous structure is a sanitary tissue product.
